(19) United States
(12) Patent Application Publication
(10) Pub. No.: US 2022/0267509 A1
(43) Pub. Date: Aug. 25, 2022

(54) POLYURETHANE-BASED PHOTOCHROMIC RESIN LENS AND PREPARATION METHOD THEREOF

(71) Applicants: Jiangsu Conant Optical Co., Ltd., Nantong (CN); Shanghai Conant Optical Co., Ltd., Shanghai (CN)

(72) Inventors: Chuanbao WANG, Nantong (CN); Liangliang SHI, Nantong (CN); Qingbo YAN, Nantong (CN)

(21) Appl. No.: 17/334,964

(22) Filed: May 31, 2021

(30) Foreign Application Priority Data
Feb. 25, 2021 (CN) 202110211229.X

(51) Int. Cl. C08G 18/66; C08G 18/75; C08G 18/24; C08K 5/357; C08K 5/3417

(52) U.S. Cl. CPC C08G 18/66; C08G 18/758; C08G 18/242; C08K 5/357; C08K 5/3417

(57) ABSTRACT

The present invention discloses a polyurethane-based photochromic resin lens and a preparation method thereof. The lens includes the following ingredients: 100 weight parts of polyurethane monomers, 0.01-0.1 weight part of an initiator, 0.1-10 weight parts of an additive and 0.01-0.2 weight part of color changing powder, wherein the additive is a molecular weight modifier. The photochromic resin lens of the present invention uses a polyurethane base to realize substrate color change, the impact-resistant strength is high, a photochromic effect is good, a visible light transmittance of the lens after hard coating can reach about 93%, and after the deepest color change depth is reached under ultraviolet irradiation, the visible light transmittance is only 15-25%.

This application claims priority to Chinese Patent Application Ser. No. CN202110211229.X filed on 25 Feb. 2021.

### BACKGROUND

### Technical Field

The present invention belongs to the field of a resin lens, and more particularly relates to a polyurethane-based photochromic resin lens and a preparation method thereof.

### Related Art

The ultraviolet region accounts for 7% of the total solar radiation energy, excessive ultraviolet rays may cause photochemical reactions, and especially cause harm to the skin, eyes, immune system and the like of a human body, and attention needs to be paid to protection, so that people engaged in outdoor activities need to avoid exposure to sunlight for a long time. The eye is the most sensitive part to ultraviolet rays, acute conjunctivitis and retinal diseases may be caused after the long-period multi-time exposure to ultraviolet rays, and people engaged in outdoor activities should wear color change sunglasses capable of shielding the ultraviolet rays. Ultraviolet radiation is also an important factor for senile cataract.

At present, color change lenses popular in the market are mainly divided into two kinds: one kind is substrate color change lenses, and the other kind is dip-coating or spin coating color change lenses. The two kinds of lenses respectively have the respective advantages and disadvantages. The advantages of the dip-coating or spin coating color change lenses are uniform color change and no cat-eye problem, but the disadvantages are high price and low qualification rate. The advantages of the substrate color change lenses are low price, good color change depth and good fading speed, but the substrate color change lenses are made of acrylic materials, the refractive index of most lenses is 1.56, and the refractive index of few lenses is 1.60. The greatest problem of the acrylic materials is poor impact-resistant performance, and additionally, a few of 1.56 materials contain low-toxicity raw materials, so that developed countries in the world including Europe and America do not like this kind of lenses. Mitsui Co., Ltd. in Japan developed a polyurethane type high-refractive-index resin lens, and due to acid-base properties of raw materials, products obtained through polymerization almost have no network space, and are difficult to realize color change, so there is no color change lens of this kind in the market at present.

### SUMMARY

The objective of the present invention is to provide a polyurethane-based photochromic resin lens and to disclose a preparation method of the polyurethane-based photochromic resin lens by aiming at the above defects. A resin lens with a refractive index being 1.60 can be prepared, a color change effect can be achieved, additionally, the optical performance of the lens is not changed, impact-resistant strength is high, a visible light transmittance of the lens after hard coating reaches about 93%, and after the deepest color change depth is reached under ultraviolet irradiation, the visible light transmittance is only 15-25%.

Compared to the prior art, the present invention has the following beneficial effects:

A high-refractive-index photochromic resin lens includes the following ingredients: 100 weight parts of polyurethane monomers, 0.01-0.1 weight part of an initiator, 0.1-10 weight parts of an additive and 0.01-0.2 weight part of color changing powder. The additive is a molecular weight modifier.

The high-refractive-index photochromic resin lens of the present invention preferably includes the following ingredients: 100 weight parts of polyurethane monomers, 0.02-0.06 weight part of an initiator, 1-5 weight parts of an additive and 0.03-0.1 weight part of color changing powder. The additive is a molecular weight modifier.

Preferably, the above polyurethane monomers are a mixture of 2,5(or 2,6)-bis(isocyanatomethyl)-bicyclo[2,2,1]heptane, pentaerythritol tetra(3-mercaptopropionate) and 4-mercaptomethyl-3,6-dithia-1,8-octanedithiol, and a mass ratio is 35-55:15-35:20-40.

Preferably, the above initiator is one or more of dimethyl carbonate, diethyl carbonate, N-dicyclohexylmethylamine, N,N-dimethylcyclohexylamine, dimethyltin dichloride and dibutyltin dichloride. By using the initiator, the reaction is mild and is easy to control.

Preferably, the above molecular weight modifier is polyether polyol with a weight average molecular weight of 2000-10000, and preferably one of polypropylene oxide glycol, polytetrahydrofuran glycol, polyvinyl alcohol or propylene oxide and ethylene oxide copolymers. By adding the molecular weight modifier, a substance with certain molecular weight participates in the reaction to increase a network space, so that color change molecules can achieve rotary color change, and a color change effect is improved.

Preferably, the above color changing powder is one or a mixture of two of photochromic organic substances of spiropyranes and spirooxazines.

Preferably, the above lens ingredients further include a mold release agent, and a mass ratio of resin monomers to the mold release agent is 100:0.0001-0.005, and preferably 100:0.001-0.003.

A preparation method of the high-refractive-index photochromic resin lens includes the following steps:

(1) dissolving the color changing powder and the initiator, proportionally mixing the polyurethane monomers, the molecular weight modifier, the dissolved initiator and color changing powder and the mold release agent, performing stirring for 30-60 min under the condition of 10° C., and then performing still standing in vacuum for 30-45 min;

(2) filtering a material prepared in step (1), and then, injecting the material into a mold to be sealed; and

(3) sequentially performing primary curing and secondary curing on the mold subjected to material pouring in step (2).

The polyurethane monomers in above step (1) are a mixture of 2,5(or 2,6)-bis(isocyanatomethyl)-bicyclo[2,2,1]heptane, pentaerythritol tetra(3-mercaptopropionate) and 4-mercaptomethyl-3,6-dithia-1,8-octanedithiol. When being mixed, each ingredient is added according to the following sequence: taking partial 2,5(or 2,6)-bis(isocyanatomethyl)-bicyclo[2,2,1]heptane to respectively dissolve the color changing powder and the initiator, after the dissolution is completed, mixing the material with the rest 2,5(or 2,6)-bis(isocyanatomethyl)-bicyclo[2,2,1]heptane and the molecular weight modifier, lowering the temperature to 10° C., and then, adding pentaerythritol tetra(3-mercaptopropionate) and 4-mercaptomethyl-3,6-dithia-1,8-octanedithiol.

The material prepared in the above step (2) is filtered through a 1 μm filter, the mold is a glass mold, and sealing is performed by using an adhesive tape.

In the above step (3), curing curves in primary curing are as follows: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h. A speed is constant in the temperature raising and lowering processes.

In the above step (3), a curing temperature of secondary curing is 105-110° C., and the time is 2.5 h.

Preferably, a preparation method of the high-refractive-index photochromic resin lens specifically includes the following steps:

(1) proportioning: proportionally weighing each ingredient, firstly dissolving an initiator by a proper amount of 2,5(or 2,6)-bis(isocyanatomethyl)-bicyclo[2,2,1]heptane for about 30-60 min; at the same time, dissolving color changing powder by 10% of 2,5(or 2,6)-bis(isocyanatomethyl)-bicyclo[2,2,1]heptane for about 60 min; adding the rest 2,5(or 2,6)-bis(isocyanatomethyl)-bicyclo[2,2,1]heptane, a mold release agent, a modifier and the dissolved color change liquid into a proportioning kettle, and performing stirring till complete dissolution; adding the dissolved initiator into the reaction kettle to be stirred for 10 min, lowering the temperature of the raw materials to about 10° C., then adding pentaerythritol tetra(3-mercaptopropionate) and 4-mercaptomethyl-3,6-dithia-1,8-octanedithiol, and performing stirring for 30-60 min in 10° C. water bath; and finally, performing still standing in vacuum for 30-45 min;

(2) material pouring: filtering the material uniformly mixed in step (1) through a 1 μm filter, then, injecting the material into a glass mold, and performing sealing by using an adhesive tape;

(3) primary curing: putting the mold subjected to material pouring in step (2) into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, wherein a speed is constant in the temperature raising and lowering processes;

(4) mold opening, edging and cleaning: performing mold opening after curing forming, performing edge chamfering by an edger, and then performing surface cleaning; and

(5) secondary curing: putting the cleaned lens into the curing furnace again to be subjected to secondary curing at a curing temperature of 105-110° C. for 2.5 h.

After the above preparation steps are completed, a hardening layer and an antireflecting film layer can be plated onto a surface of the lens. The hardening layer is obtained by plating a hardening layer on the surface of the lens by using a dip-coating method. The antireflecting film layer is obtained by plating silicon dioxide, zirconium dioxide, indium tin oxide and a waterproof layer on the surface of the lens by using a vacuum film plating method.

The photochromic resin lens of the present invention and the preparation method thereof can be applied to preparation of the photochromic resin lens with the refractive index of 1.56, 1.60 or 1.67.

Compared to the prior art, the present invention has the following beneficial effects:

(1) The photochromic resin lens of the present invention uses a polyurethane base to realize substrate color change, the impact-resistant strength is high, a photochromic effect is good, a visible light transmittance of the lens after hard coating can reach about 93%, and after the deepest color change depth is reached under ultraviolet irradiation, the visible light transmittance is only 15-25%.

(2) The present invention selects the specific initiator and modifier, so that the prepared 1.60 polyurethane lens can achieve color change, and the optical performance of the lens is not changed.

(3) The preparation process of the present invention is simple and easy to operate, can be used for preparing a single vision lens, and can also be used for manufacturing a bifocal lens, a trifocal lens and a multifocal lens, and advantages are greater than those of a spin coating color change lens (the spin coating color change lens can only be used for preparing the single vision lens).

(4) The cost of the lens prepared by the present invention is much lower than that of the spin coating color change lens, huge advantages are achieved, and the popularization is easy.

### DETAILED DESCRIPTION

Hereinafter, exemplary implementations of the present invention will be described in more detail with reference to specific embodiments.

The followings are raw materials and auxiliaries used in the embodiments:

Polyurethane monomer: a mixture of 2,5(or 2,6)-bis(isocyanatomethyl)-bicyclo[2,2,1]heptane, pentaerythritol tetra(3-mercaptopropionate) and 4-mercaptomethyl-3,6-dithia-1,8-octanedithiol: Mitsui Co., Ltd. in Japan

Dimethyl carbonate: Shenzhen Division Tech Co., Ltd.

N-dicyclohexylmethylamine: Shanghai Lianshuo Biological Technology Co., Ltd.

N,N-dimethylcyclohexylamine: Shanghai Lianshuo Biological Technology Co., Ltd.

Dimethyltin dichloride: Shanghai Aladdin Bio-Chem Technology Co., Ltd.

Color changing powder: Guangzhou Kehan Science and Technology Co., Ltd.

Polypropylene oxide glycol: Mitsubishi Corporation in Japan

Polytetrahydrofuran glycol: Mitsubishi Corporation in Japan

Propylene oxide and ethylene oxide copolymers: Shanghai YuanMu Biological Technology Co., Ltd.

Mold release agent: JP-506H, Mitsui Co., Ltd. in Japan.

### EXAMPLE 1

A preparation method of a polyurethane-based photochromic resin lens with a refractive index being 1.60 included the following steps:

(1) 0.01 g of dimethyl carbonate was dissolved by 5.5 g of 2,5(or 2,6)-bis(isocyanatomethyl)-bicyclo[2,2,1]heptane for about 30-60 min. At the same time, 0.03 g of color changing powder was dissolved by 4.5 g of 2,5(or 2,6)-bis(isocyanatomethyl)-bicyclo[2,2,1]heptane for about 60 min to obtain color change liquid. 35 g of 2,5(or 2,6)-bis(isocyanatomethyl)-bicyclo[2,2,1]heptane, 0.1 mg of a mold release agent, 0.1 g of polypropylene oxide glycol and the dissolved color change liquid were added in a proportioning kettle, and were stirred till complete dissolution. The dissolved dimethyl carbonate solution was added into a reaction kettle to be stirred for 10 min, cooling was performed to reach about 10° C., 30 g of pentaerythritol tetra(3-mercaptopropionate) and 25 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

### EXAMPLE 2

A preparation method of a polyurethane-based photochromic resin lens with a refractive index being 1.60 included the following steps:

(1) 0.02 g of N-dicyclohexylmethylamine was dissolved by 5 g of 2,5(or 2,6)-bis(isocyanatomethyl)-bicyclo[2,2,1]heptane for about 30-60 min. At the same time, 0.06 g of color changing powder was dissolved by 5 g of 2,5(or 2,6)-bis(isocyanatomethyl)-bicyclo[2,2,1]heptane for about 60 min to obtain color change liquid. 40 g of 2,5(or 2,6)-bis(isocyanatomethyl)-bicyclo[2,2,1]heptane, 1 mg of a mold release agent, 1 g of polytetrahydrofuran glycol and the dissolved color change liquid were added in a proportioning kettle, and were stirred till complete dissolution. The dissolved N-dicyclohexylmethylamine solution was added into a reaction kettle to be stirred for 10 min, cooling was performed to reach about 10° C., 20 g of pentaerythritol tetra(3-mercaptopropionate) and 30 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

### EXAMPLE 3

A preparation method of a polyurethane-based photochromic resin lens with a refractive index being 1.60 included the following steps:

(1) 0.06 g of N,N-dimethylcyclohexylamine was dissolved by 6 g of 2,5(or 2,6)-bis(isocyanatomethyl)-bicyclo[2,2,1]heptane for about 30-60 min. At the same time, 0.08 g of color changing powder was dissolved by 4 g of 2,5(or 2,6)-bis(isocyanatomethyl)-bicyclo[2,2,1]heptane for about 60 min to obtain color change liquid. 30 g of 2,5(or 2,6)-bis(isocyanatomethyl)-bicyclo[2,2,1]heptane, 3 mg of a mold release agent, 5 g of propylene oxide and ethylene oxide copolymers and the dissolved color change liquid were added in a proportioning kettle, and were stirred till complete dissolution. The dissolved N,N-dimethylcyclohexylamine solution was added into a reaction kettle to be stirred for 10 min, cooling was performed to reach about 10° C., 25 g of pentaerythritol tetra(3-mercaptopropionate) and 35 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

### EXAMPLE 4

A preparation method of a polyurethane-based photochromic resin lens with a refractive index being 1.60 included the following steps:

(1) 0.08 g of dimethyltin dichloride was dissolved by 5 g of 2,5(or 2,6)-bis(isocyanatomethyl)-bicyclo[2,2,1]heptane for about 30-60 min. At the same time, 0.15 g of color changing powder was dissolved by 5 g of 2,5(or 2,6)-bis(isocyanatomethyl)-bicyclo[2,2,1]heptane for about 60 min to obtain color change liquid. 40 g of 2,5(or 2,6)-bis(isocyanatomethyl)-bicyclo[2,2,1]heptane, 5 mg of a mold release agent, 8 g of polypropylene oxide glycol and the dissolved color change liquid were added in a proportioning kettle, and were stirred till complete dissolution. The dissolved dimethyl carbonate solution was added into a reaction kettle to be stirred for 10 min, cooling was performed to reach about 10° C., 30 g of pentaerythritol tetra(3-mercaptopropionate) and 20 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

### Comparative Example 1

An existing acrylic photochromic resin lens with a refractive index being 1.60.

### Comparative Example 2

A preparation method of a polyurethane-based photochromic resin lens with a refractive index being 1.60 included the following steps:

(1) 0.02 g of dibutyltin dichloride was dissolved by 5 g of 2,5(or 2,6)-bis(isocyanatomethyl)-bicyclo[2,2,1]heptane for about 30-60 min. At the same time, 0.06 g of color changing powder was dissolved by 5 g of 2,5(or 2,6)-bis(isocyanatomethyl)-bicyclo[2,2,1]heptane for about 60 min to obtain color change liquid. 40 g of 2,5(or 2,6)-bis(isocyanatomethyl)-bicyclo[2,2,1]heptane, 1 mg of a mold release agent, 1 g of polytetrahydrofuran glycol and the dissolved color change liquid were added in a proportioning kettle, and were stirred till complete dissolution. The dissolved N-dicyclohexylmethylamine solution was added into a reaction kettle to be stirred for 10 min, cooling was performed to reach about 10° C., 20 g of pentaerythritol tetra(3-mercaptopropionate) and 30 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

### Comparative Example 3

A preparation method of a polyurethane-based photochromic resin lens with a refractive index being 1.60 included the following steps:

(1) 0.02 g of N-dicyclohexylmethylamine was dissolved by 5 g of 2,5(or 2,6)-bis(isocyanatomethyl)-bicyclo[2,2,1]heptane for about 30-60 min. At the same time, 0.06 g of color changing powder was dissolved by 5 g of 2,5(or 2,6)-bis(isocyanatomethyl)-bicyclo[2,2,1]heptane for about 60 min to obtain color change liquid. 40 g of 2,5(or 2,6)-bis(isocyanatomethyl)-bicyclo[2,2,1]heptane, 1 mg of a mold release agent and the dissolved color change liquid were added in a proportioning kettle, and were stirred till complete dissolution. The dissolved N-dicyclohexylmethylamine solution was added into a reaction kettle to be stirred for 10 min, cooling was performed to reach about 10° C., 20 g of pentaerythritol tetra(3-mercaptopropionate) and 30 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

### Comparative Example 4

A preparation method of a polyurethane-based photochromic resin lens with a refractive index being 1.60 included the following steps:

(1) 0.02 g of N-dicyclohexylmethylamine was dissolved by 3 g of 2,5(or 2,6)-bis(isocyanatomethyl)-bicyclo[2,2,1]heptane for about 30-60 min. At the same time, 0.06 g of color changing powder was dissolved by 3 g of 2,5(or 2,6)-bis(isocyanatomethyl)-bicyclo[2,2,1]heptane for about 60 min to obtain color change liquid. 24 g of 2,5(or 2,6)-bis(isocyanatomethyl)-bicyclo[2,2,1]heptane, 1 mg of a mold release agent, 10 g of polytetrahydrofuran glycol and the dissolved color change liquid were added in a proportioning kettle, and were stirred till complete dissolution. The dissolved N-dicyclohexylmethylamine solution was added into a reaction kettle to be stirred for 10 min, cooling was performed to reach about 10° C., 60 g of pentaerythritol tetra(3-mercaptopropionate) and 10 g of 4-mercaptomethyl-3,6-dithia-1,8-octanedithiol were added, stirring was performed for 30-60 min in 10° C. water bath, and finally, still standing was performed in vacuum for 30-45 min.

(2) Material pouring: the material uniformly mixed in step (1) was filtered through a 1 μm filter, and then injected into a glass mold, and sealing was performed by using an adhesive tape.

(3) Primary curing: the mold subjected to material pouring in step (2) was put into a curing furnace to be subjected to primary curing forming according to the following curing time and temperature curves: performing heat insulation for 5 h at an initial temperature of 20° C., raising the temperature to 50-55° C. in 3 h, raising the temperature to 70-75° C. in 5 h, raising the temperature to 80-85° C. in 2 h, raising the temperature to 90-95° C. in 1 h, raising the temperature to 100-105° C. in 2 h, and lowering the temperature to 75-80° C. in 1 h, and a speed was constant in the temperature raising and lowering processes.

(4) Mold opening, edging and cleaning: mold opening was performed after curing forming, edge chamfering was performed by an edger, and then, surface cleaning was performed.

(5) Secondary curing: the cleaned lens was put into the curing furnace again to be subjected to secondary curing at a curing temperature of 105-110° C. for 2.5 h.

After the above preparation was completed, a hardening layer was plated on the surface of the lens by using a dip-coating method, and an antireflecting film layer consisting of silicon dioxide, zirconium dioxide, indium tin oxide and a waterproof layer was plated on the surface of the lens by using a vacuum film plating method.

The lenses of the above embodiments and comparative examples were respectively subjected to impact-resistant test, color change performance test and optical performance test, and the results were as shown in Table 1.

TABLE 1
Performance comparison of lenses of
embodiments and comparative examples

| | Impact- | Color | Visible | |
|---|---|---|---|---|
| | resistant | change depth | light | Refractive |
| | perfor- | (visible light | transmit- | index |
| Sample | mance | transmittance) | tance | n_{d} |
| Example 1 | OK | 23% | 93.3% | 1.590 |
| Example 2 | OK | 20% | 92.9% | 1.591 |
| Example 3 | OK | 15% | 91.1% | 1.592 |
| Example 4 | OK | 19% | 92.0% | 1.593 |
| Comparative | No | 21% | 93.5% | 1.590 |
| Example 1 | | | | |
| Comparative | OK | 75% | 94.1% | 1.591 |
| Example 2 | | | | |
| Comparative | OK | 94.5% | 94.5% | 1.591 |
| Example 3 | | | | |
| Comparative | Lens white- | Lens white- | Lens white- | Lens white- |
| Example 4 | turbid | turbid | turbid | turbid |

Note:
A visible light transmittance test instrument was TM-3; a color change performance test instrument was a transmittance test instrument; impact-resistant test equipment was a 1.6 g small ball falling from a height of 1.27 m, and a test result of no crack after 3 times was regarded as OK; and a refractive index test instrument was an Abbe refractometer.

From the above table, the polyurethane-based photochromic resin lens of the present invention had high impact-resistant strength, good photochromic effects and high visible light transmittance; when a conventional organic tin initiator was used, or no molecular weight modifier was added, the color change effects were not ideal; and when another proportioning ratio was adopted, the lens white-turbid would be caused, i.e., the lens was non-transparent, and a product was unqualified.

Each embodiment of the present invention has been described above, and the foregoing description is illustrative, not exhaustive, and is not limited to the disclosed embodiments. Many modifications and variations will be apparent to those of ordinary skill in the art without departing from the scope and technical principles of the described embodiments, and such modifications and variations should also be regarded to be within the protection scope of the present invention.

What is claimed is:

1. A polyurethane-based photochromic resin lens, wherein the lens comprises the following ingredients: 100 weight parts of polyurethane monomers, 0.01-0.1 weight part of an initiator, 0.1-10 weight parts of an additive and 0.01-0.2 weight part of color changing powder, wherein the additive is a molecular weight modifier.

2. The polyurethane-based photochromic resin lens according to claim 1, wherein the lens comprises the following ingredients: 100 weight parts of polyurethane monomers, 0.02-0.06 weight part of an initiator, 1-5 weight parts of an additive and 0.03-0.1 weight part of color changing powder, wherein the additive is a molecular weight modifier.

3. The polyurethane-based photochromic resin lens according to claim 1, wherein the polyurethane monomers are a mixture of 2,5(or 2,6)-bis(isocyanatomethyl)-bicyclo[2,2,1]heptane, pentaerythritol tetra(3-mercaptopropionate) and 4-mercaptomethyl-3,6-dithia-1,8-octanedithiol, and a mass ratio is 35-55:15-35:20-40.

4. The polyurethane-based photochromic resin lens according to claim 1, wherein the initiator is one or more of dimethyl carbonate, diethyl carbonate, N-dicyclohexylmethylamine, N,N-dimethylcyclohexylamine, dimethyltin dichloride and dibutyltin dichloride.

5. The polyurethane-based photochromic resin lens according to claim 1, wherein the molecular weight modifier is polyether polyol with a weight average molecular weight of 2000-10000.

6. The polyurethane-based photochromic resin lens according to claim 5, wherein the polyether polyol is one of polypropylene oxide glycol, polytetrahydrofuran glycol, polyvinyl alcohol or propylene oxide and ethylene oxide copolymers.

7. The polyurethane-based photochromic resin lens according to claim 1, wherein the color changing powder is one or a mixture of two of photochromic organic substances of spiropyranes and spirooxazines.

8. The polyurethane-based photochromic resin lens according to claim 1, wherein ingredients of the lens further comprise a mold release agent, a content of the mold release agent is 100:0.0001-0.005, and preferably 100:0.001-0.003.

9. A preparation method of the polyurethane-based photochromic resin lens according to claim 1, comprising the following steps:
(1) dissolving the color changing powder and the initiator, proportionally mixing the polyurethane monomers, the molecular weight modifier, the dissolved initiator and color changing powder and the mold release agent, performing stirring for 30-60 min under the condition of 10° C., and then performing still standing in vacuum for 30-45 min;
(2) filtering a material prepared in step (1), and then, injecting the material into a mold to be sealed; and
(3) sequentially performing primary curing and secondary curing on the mold subjected to material pouring in step (2).

10. The preparation method of the polyurethane-based photochromic resin lens according to claim 9, wherein the polyurethane monomers in step (1) are a mixture of 2,5(or 2,6)-bis(isocyanatomethyl)-bicyclo[2,2,1]heptane, pentaerythritol tetra(3-mercaptopropionate) and 4-mercaptomethyl-3,6-dithia-1,8-octanedithiol; and when being mixed, each ingredient is added according to the following sequence: taking partial 2,5(or 2,6)-bis(isocyanatomethyl)-bicyclo[2,2,1]heptane to respectively dissolve the color changing powder and the initiator, after the dissolution is completed, mixing the material with the rest 2,5(or 2,6)-bis(isocyanatomethyl)-bicyclo[2,2,1]heptane and the molecular weight modifier, lowering the temperature to 10° C., and then, adding pentaerythritol tetra(3-mercaptopropionate) and 4-mercaptomethyl-3,6-dithia-1,8-octanedithiol.
